(19) United States
(12) Patent Application Publication
(10) Pub. No.: US 2007/0029787 A1
(43) Pub. Date: Feb. 8, 2007

(54) Apparatuses and methods for protecting confidential information

(76) Inventors: Robert Lee Loftin III, Birmingham, AL (US); Charles Robert Tate, Birmingham, AL (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/487,250

(22) Filed: Jul. 14, 2006

Related U.S. Application Data
(60) Provisional application No. 60/699,314, filed on Jul. 14, 2005.

(51) Int. Cl. B42D 15/00

(52) U.S. Cl. 283/74

(57) ABSTRACT

A perforated lamina is used to obfuscate confidential information. In one exemplary embodiment, text is printed on the lamina. The text printed to perforated regions of the lamina resides on a printing medium, and other portions of the text reside on the lamina. Thus, separating the lamina from the printing medium obscures the text.

### CROSS REFERENCE TO RELATED APPLICATION

This application claims priority to U.S. Provisional Application No. 60/699,314, entitled “System and Method for Protecting Confidential Information,” and filed on Jul. 14, 2005, which is incorporated herein by reference.

### RELATED ART

Documents, such as medical labels, financial records and other items, often contain sensitive or confidential information. As a safeguard procedure, documents are sometimes shredded, burned, or otherwise disposed in order to protect such confidential information.

In the case of a prescription label on a medicine container, such as a bottle or box, it is typically required (via an accreditation agency) that a hospital or care facility safeguard medical information when discarding medicine containers. A known method of safeguarding medical information includes removing the prescription label from the container and then shredding the label. Such a shredding method generally complies with safeguarding requirements, but is somewhat burdensome in terms of time and effort. Another methodology of protecting information is to paint over the label, for example, using “Liquid Paper®” and then disposing the container in a non-secure trashcan. In a variation of this method, a marker with dark ink can be used to mark out confidential information thereby concealing the information from an unauthorized viewer.

Confidential information is not limited to medical information. For example, when an application for a loan is completed, confidential information is supplied to the financial institution. However, after the loan is approved, it may be desirable to keep the application on file, but it may be desirable to remove from the application at least some of the confidential information, such as a person's social security number, for example. In such instances, it is possible to obscure the information by covering it with “Liquid Paper®” or marking through it with a pen other writing instrument.

There are many other instances when it may be desirable to protect confidential information from unauthorized viewers. It is generally desirable to have an efficient methodology for safeguarding confidential information.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a diagram illustrating an exemplary medical label containing confidential information.

FIG. 2 is a diagram of an exemplary document containing confidential information.

FIG. 3A illustrates an exemplary apparatus for protecting confidential information in accordance with the present disclosure.

FIG. 3B illustrates an exemplary medical label of the apparatus depicted in FIG. 3A once a lamina has been removed from the medical label.

FIG. 3C illustrates the lamina that has been removed from the medical label of FIG. 3B.

FIG. 3D illustrates the medical label of FIG. 3A affixed to an exemplary prescription bottle.

FIG. 4A illustrates another exemplary apparatus for protecting confidential information in accordance with the present disclosure.

FIG. 4B illustrates an exemplary document of the apparatus depicted in FIG. 4A once a lamina has been removed from the document.

FIG. 4C illustrates the lamina that has been removed from the document of FIG. 4B.

FIG. 5A illustrates a document similar to the one of FIG. 4A after a lamina, as depicted in FIG. 5B, has been removed from the document to protect confidential information printed on the document and lamina.

FIG. 5B illustrates an exemplary lamina that has been removed from the document of FIG. 5A.

FIG. 6 illustrates an exemplary roll of lamina material that may be used to form a lamina for protecting confidential information according to the present disclosure.

FIG. 7 illustrates an exemplary lamina formed from the lamina material depicted in FIG. 6.

FIG. 8 illustrates the lamina of FIG. 7 as it is being applied to a document.

FIG. 9 illustrates an exemplary lamina attached to a document.

FIG. 10 illustrates an exemplary methodology for protecting confidential information in accordance with the present disclosure.

FIG. 11A illustrates a top view of an exemplary label that can be used for protecting confidential information in accordance with the present disclosure.

FIG. 11B illustrates a side view of the label of FIG. 11A.

FIG. 12A illustrates a top view of the exemplary label of FIG. 11A once the top layer of the label has been perforated to form a plurality of segments.

FIG. 12B illustrates a side view of the label of FIG. 12A.

FIG. 13A illustrates a side view of the label of FIG. 12B once a bottom layer of the label has been removed and the label has been attached to a document.

FIG. 13B illustrates a side view of the label of FIG. 13A once the top layer has been removed leaving the segments formed by perforating the top layer.

FIG. 13C illustrates a top view of the label depicted in FIG. 13B.

### DETAILED DESCRIPTION

The present disclosure generally pertains to apparatuses and methods for protecting confidential information in an effort to reduce the likelihood of an unauthorized person viewing and comprehending such information. An apparatus in accordance with one embodiment of the present disclosure comprises a perforated lamina having an adhesive material on one side. The lamina is placed on a surface of a printing medium (e.g., a document or label) on which text is to be printed, and the adhesive material adheres the lamina to the medium's surface. Text is then printed on the lamina and the medium by a conventional printer or otherwise. Holes in the lamina allow portions of the ink to pass through the lamina and reside on the medium's surface. The remaining portions of the ink reside on the lamina.

After reading or otherwise using the medium, a user can remove the lamina by pulling it from the medium's surface. The holes in the lamina are patterned such that, once the lamina is removed from the medium's surface, the ink remaining on the medium's surface is insufficient for allowing the text to be read from the medium and the ink remaining on the lamina is insufficient for allowing the text to be read from the lamina. Thus, the user can throw away or otherwise dispose of the medium without worrying that a third party may be able to read the text if such party gains access to the medium. In essence, removal of the lamina destroys the readability of the text without having to physically destroy the medium, such as by feeding it through a shredder, which is not always available or convenient.

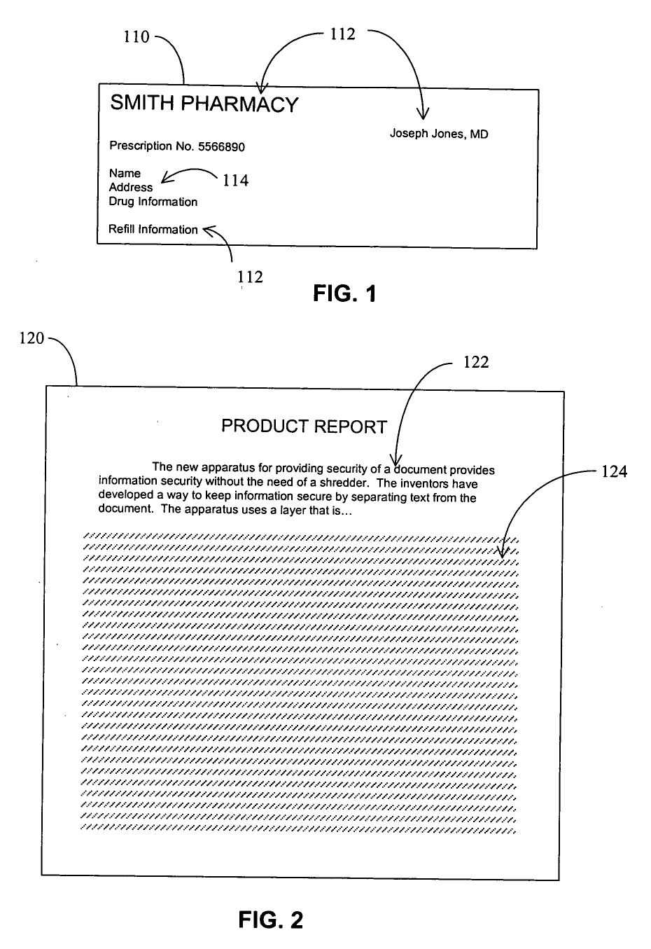

FIG. 1 illustrates an exemplary medical label 110 that has exemplary confidential information 114 and public information 115. Confidential information generally refers to any information that at least one person desires to keep secret with respect at least one other person. Public information generally refers to any non-confidential information.

Once the information 112 and 114 is printed, the medical label 110 may be affixed to a container (not shown) for holding pills or other medicine. For simplicity, the information shown on the exemplary medical label 110 in FIG. 1 is not extensive as normally found on actual prescription labels, but the medical label 110 is nevertheless sufficient for illustrating an exemplary methodology for protecting confidential information in accordance with the present disclosure. The confidential information 114 as shown represents the name and address of a patient for whom a prescribed drug is intended, as well as “drug information,” which could include the drug's name or instructions for administering the drug. Public information 112 on the medical label 110 includes the name of the doctor, the name of the drug store, and the number of refills. The information shown in FIG. 1 is for illustrative purposes only, and in other examples, the confidential information 114 and public information 112 may comprise other types of information.

After a patient has completed the treatment provided by the prescribed medicine or no longer needs the medicine, the medical container (not shown) on which the label 110 is affixed can be discarded. If the confidential information 114 has not been removed or otherwise rendered unreadable, an unauthorized person may gain access to the confidential information 114. In some instances, the patient may remove the label 110 from its container and shred it or mark through the confidential information 114 with a dark marker thereby protecting the confidential information 114. However, in other instances, such as when a shredder or a marker is not readily available, the container with the medical label 110 may be placed in a trash container without taking any steps for obscuring the confidential information 114. In instances when no protective steps have been taken, the confidential information 114 may be available for unauthorized viewing.

Because medical and care facilities typically dispense large quantities of prescribed medicines, such facilities are particularly at risk for having unauthorized persons view confidential information 114 on medical labels 110. Hence, it is desirable for persons at such facilities to refrain from discarding medical labels in a way that may surrender confidential information. Many facilities are bound by law or policy to have confidential information safeguard processes.

FIG. 2 illustrates an exemplary document 120, which in this case is a page of a company's product report, that has both confidential information 122 and public information 124. The particular text defining the confidential information 122 and public information 124 is unimportant to the present disclosure, and the text of the public information 124 is symbolically represented as a series of “/,” although in actuality such text is likely to comprise of words or diagrams.

The document 120 may be a single page or a page within a multi-page report. The area on the document 120 containing the confidential information 122 may cover an entire page or a portion of a page as shown. In cases where there is a large number of pages within a bound report, it may be desirable to separate the pages if the confidential information is to be destroyed by shredding. If a company has a large number of documents, it may be desirable to destroy such documents by incineration. In addition to company confidential information, banks and financial institutions often have documents, such as loan applications, that contain confidential information. In some instances, it is desirable to obscure confidential information after a transaction is completed, but keep the public information for later viewing.

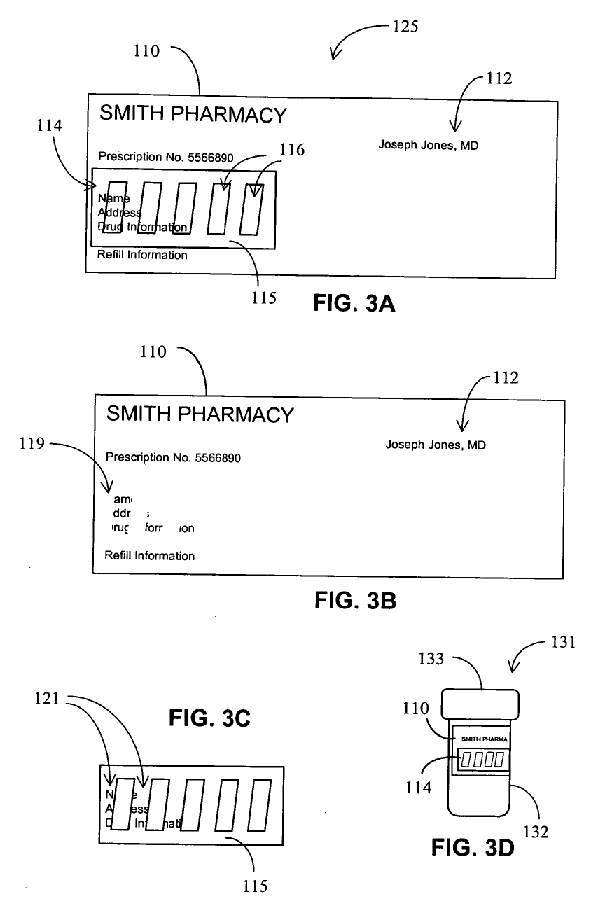

FIG. 3A depicts an exemplary apparatus 125 for protecting confidential information 114 that may be printed on a medical label 110 of other type of printing medium. Before the confidential information 114 is printed on the label 110, a lamina 115 is attached to the label 110 at an area where confidential information 114 is to be printed. Note that the confidential information 114 and/or public information 112 may be printed by a conventional printer, such as any known or future-developed laser printer. However, it is also possible for such information to be printed by other techniques, such as by a user writing such information on the label 110 with a pen, pencil, or other writing instrument. Further, although FIG. 3A depicts a medical label, other types of printing media may be used in other embodiments without departing from the principles of the present disclosure.

The lamina 115 may be attached to the label 110 via various techniques. In one exemplary embodiment, a side of the lamina 115 contacting the label 110 is preferably coated with an adhesive material before the lamina 115 is positioned on the label 110. This adhesive material adheres the lamina 115 to the label 110 until the lamina 115 is later removed by a user, as will be described in more detail hereafter.

The lamina 115 is interspersed with a plurality of perforated regions. In this regard, the lamina 115 is perforated to form holes 116 so that some ink defining the confidential information 114 can pass through the holes 116 in the lamina 115 and reside on the label 110. Accordingly, when a printer prints the confidential information 114, such information 114 is printed partially on the lamina 115 and partially on the label 110.

For example the letters “am” of the word “Name,” as well as a small portion of the letter “e,” as seen in FIG. 3A are printed on the label 110. However, the letter “N,” as well as most of the letter “e,” of the word “Name” are printed on the lamina 115 as seen in FIG. 3A. FIG. 3D shows the label 110 affixed to an exemplary prescription bottle 131. As shown by FIG. 3D, the bottle 131 comprises a container 132 with a cap 133 screwed on a top of the container 132. Other configurations of prescription bottles may be used in other embodiments.

Before disposing of the label 110, it may be desirable to obscure the confidential information 114 so that it becomes illegible. To obscure the information 114, the lamina 115 may be removed from the label 110, for example, by pulling the lamina 115 from the surface of the label 110. To facilitate removal of the entire lamina 115, the material of the lamina 115 and the adhesive material adhering the lamina 115 to the label 110 can be selected so that the lamina 115, when desired, can be easily removed from the label 110 without tearing or ripping.

FIGS. 3B and 3C respectively depict the label 110 and the lamina 115 after the lamina 115 has been removed from the label 110. The portions of the confidential information 114 remaining on the label 110 as shown in FIG. 3B, after the lamina 115 is removed, are referred to as the “label remnants 119.” The portions of the confidential information 114 remaining on the lamina 115 as shown by FIG. 3C, after the lamina 115 is removed from the substrate 117 are referred to as the “lamina remnants 121.”

As shown by FIGS. 3B and 3C, the label remnants 119 and the lamina remnants 121 are individually insufficient for conveying the confidential information 114 to a viewer. Thus, the confidential information 114 is effectively obscured when the lamina 115 is removed from the label 110.

Although the holes 116 in the lamina 115 for the exemplary embodiment depicted by FIGS. 3A and 3C have a generally rhombus shape and are large enough to leave whole letters on the label 110, the lamina 115 may have perforations of other shapes and/or sizes. For example, any of the holes 116 may be smaller than the individual letters of the confidential information 114. Further, it is unnecessary for each of the holes 116 to be of the same size and/or shape. For example, holes 116 of differing shapes may be randomly scattered across the surface of the lamina 115. Various other patterns of the holes 116 are possible in other embodiments.

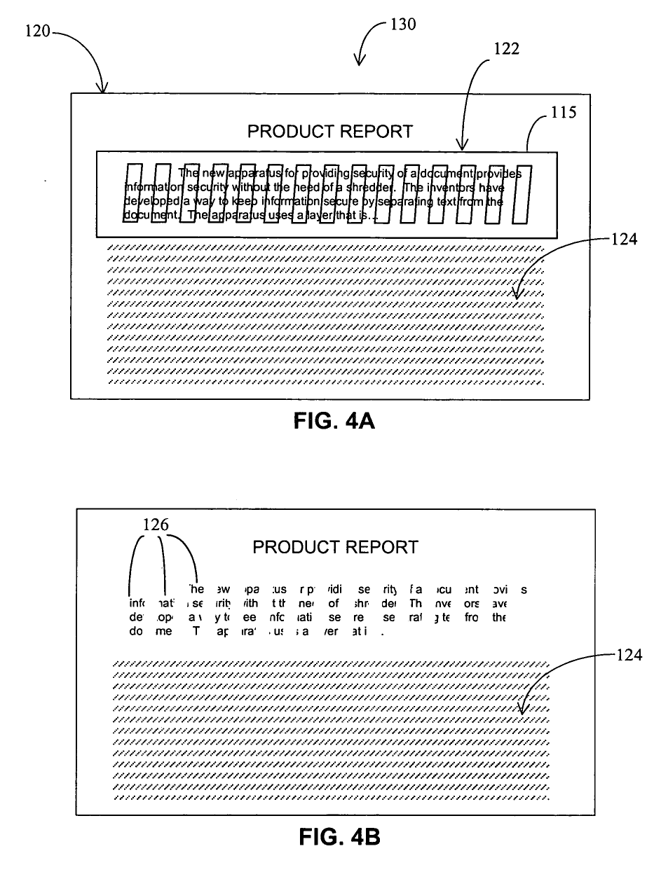

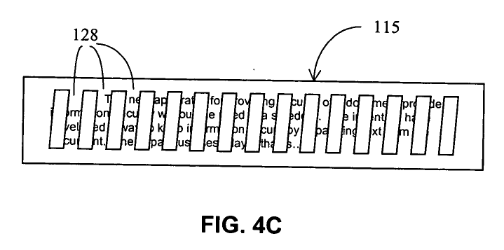

FIG. 4A illustrates another exemplary apparatus 130 for protecting confidential information. The apparatus 130 of FIG. 4A comprises a document 120 similar to the one shown in FIG. 2. However, before at least the confidential information 122 is printed on the document 120 of FIG. 4A, a lamina 115 is affixed to the document 120 similar to the way that lamina 115 of FIG. 3A is attached to the label 110. Further, confidential information 122 is printed on the document 120 such that a portion of the confidential information 122 resides on the lamina 115. As shown by FIGS. 4B and 4C, the lamina 115 may be removed from the document 120 to obscure the confidential information 122. In this regard, the document remnants 126 remaining on the document 120 are insufficient for enabling a viewer of the document 120 to comprehend the confidential information 122, and lamina remnants 128 remaining on the lamina 115 are insufficient for enabling a viewer of the lamina 115 to comprehend the confidential information 122.

Note that the lamina 115 may be composed of various materials. In one exemplary embodiment, the lamina 115 is composed of a thin layer of polyester material, such as Mylar. Although various thicknesses of the lamina 115 are possible, the lamina 115 has a thickness of less than approximately one (1) mil in one exemplary embodiment.

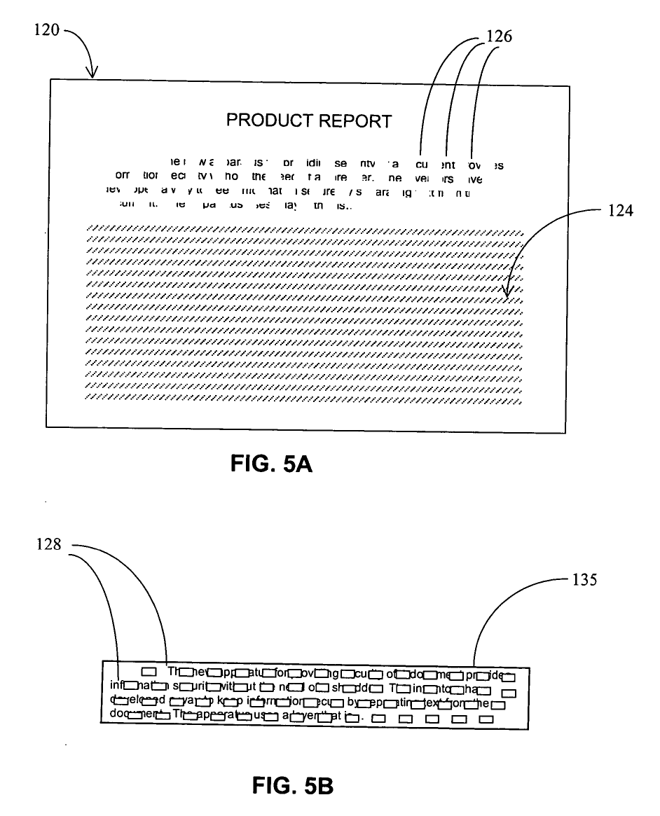

FIG. 5B illustrates another lamina 135 having holes 132 of a different pattern as compared to the lamina 115 of FIGS. 3A and 4A. The other aspects of lamina 135, such as materials and thickness, may be similar to or identical to the lamina 115 of FIGS. 3A and 4A. As described above for lamina 115, the lamina 135 of FIG. 5B is placed on the document 120 before printing of the confidential information 122 such that text defining the confidential information 122 is imprinted on both the document 120 and the lamina 135. By using the lamina 135 of FIG. 5B in lieu of the lamina 115 of FIG. 4A, the document 120 appears as shown in FIG. 5A once the lamina 135 is removed.

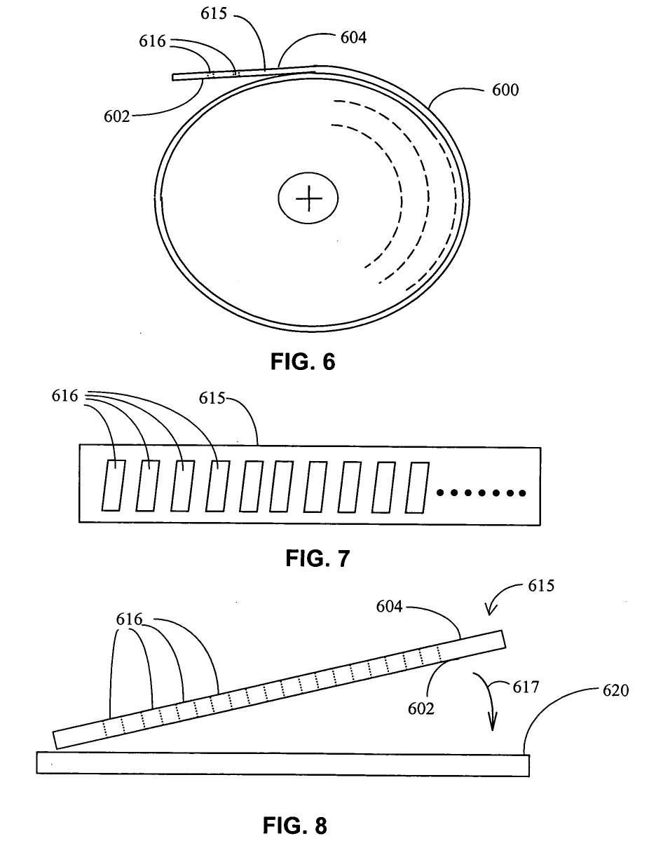

FIG. 6 illustrates an exemplary roll 600 of lamina material that may be used to form any of the laminas described herein. In this regard, the spiraled lamina material may be dispensed from the roll 600 similar to the way that masking tape may be dispensed from a roll of masking tape. In particular, the roll 600 has adhesive material deposited or otherwise formed on a bottom surface 602 of the lamina material. A top surface 604 of the lamina material has no adhesive and is capable of receiving and holding ink or toner from a conventional printer. Before the lamina material is rolled as is shown in FIG. 6, the lamina material is preferably perforated such that holes pass through the lamina material to allow ink to pass through it when confidential information is printed. FIG. 6 shows two exemplary holes 616 for simplicity, but the lamina material may have many more holes 616. A segment of the lamina material may be pulled from the roll and cut to separate the segment from the roll 600 thereby forming the lamina 615 shown in FIG. 7. This lamina 615 may be used to obscure confidential information according to the techniques described above.

FIG. 8 illustrates the lamina 615 of FIG. 7 as it is being placed for attachment to a document 620. As indicated earlier, the document 620 may be a piece of paper or any other material on which confidential information is to be printed. One end of the lamina 615 is placed against the document 620 and then the lamina 615 is pressed downward, as shown by the arrow 617, for attachment to the document 620. The attachment action can be similar to the way a piece of tape is placed and smoothed onto a piece of paper. Once the lamina 615 is secured to the document 620, confidential information may be printed on the lamina 615 and document 620. As described above, when it becomes desirable to obscure the confidential information so that a viewer cannot read the confidential information, the lamina 615 may be removed from the document 620.

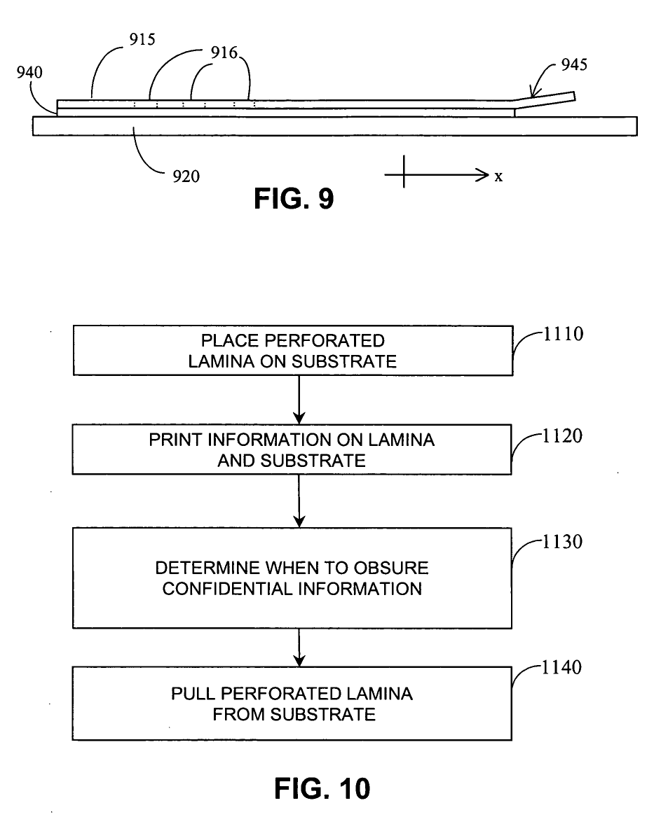

FIG. 9 illustrates an exemplary lamina 915 attached to a document 920. The lamina 915 has a layer 940 of adhesive material adhering the lamina 915 to the document 920. The thickness of layer 940 is exaggerated in FIG. 9 for illustrative purposes. The length of the lamina 915 in the x-direction is shorter than the length of the adhesive layer 940 such that one end of the lamina 915 is free of adhesive material. The portion of the lamina 915 free of adhesive material is referred to hereafter as a “tab 945.” Since adhesive material does not adhere the tab 945 to the document 920, the tab 945 can be easily gripped by a user who can then pull the lamina 915 from the document 920 while gripping the tab 945. By providing a convenient gripping point for the lamina 915, the tab 945 can facilitate removal of the lamina 915 from the document 920.

FIG. 10 illustrates an exemplary method for protecting information using a lamina, as described above. As shown by block 1110, a perforated lamina is placed on a document. Confidential information is then imprinted on the combination of the lamina and the document by applying ink from a conventional printer or otherwise, as shown by block 1120. The confidential information is then available to any viewer of the combination. At some point, a determination is made by a user to obscure the confidential information, as depicted by block 1130. The user then pulls the lamina from the document, as shown by block 1140, thereby obscuring the confidential information.

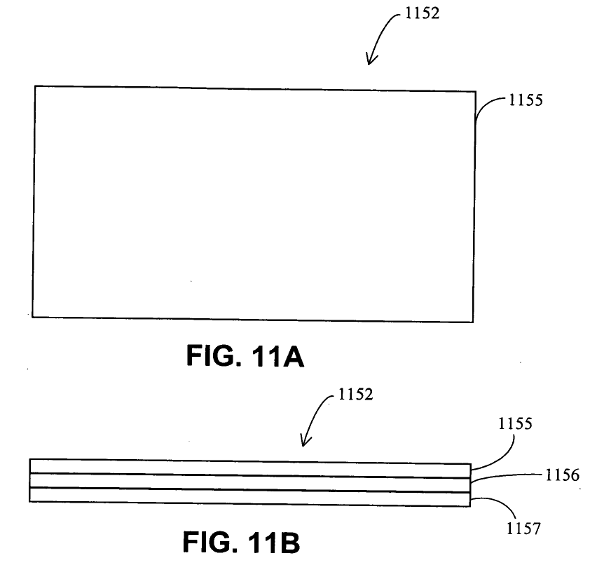

FIGS. 11A and 11B depict an exemplary label 1152 that may be used to safeguard confidential information in accordance with the techniques described herein. The label 1152 has three layers, a lamina 1155, a liner layer 1156, and a base layer 1157. Adhesive material is between the lamina 1155 and the liner layer 1156 and between the liner layer 1156 and the base layer 1157, thereby adhering the liner layer 1156 to both the lamina 1155 and base layer 1157. Further, adhesive material remains on the liner layer 1156 if the base layer 1157 is removed thereby allowing the liner layer 1156 to be adhesively attached to another object, such as a document or container (not shown in FIG. 11B), as will be described in more detail below. An exemplary label that may be used to implement the label 1152 of FIGS. 11A and 11B is sold by Morgan Adhesives Company as LM9501PB Translabel® EDP.

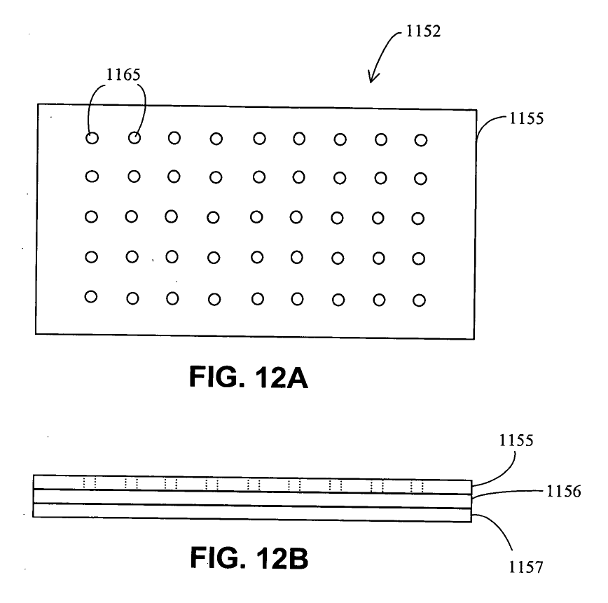

As shown by FIGS. 12A and 12B, the lamina 1155 is modified such that it is interspersed with a plurality of perforated regions. In this regard, the lamina 1155 is perforated to form segments 1165 that are separated from or easily separated from the remaining portion of the lamina 1155 so that these segments 1165 remain on the liner layer 1156 when the lamina 1155 is later removed. Note that the lamina 1155 can be die cut to form all of the segments 1165 at the same time. In addition, the cutting process does not penetrate the liner layer 1156 and the base layer 1157. A cutting process that does not penetrate all of the layers of a label is sometimes referred to as a “kiss cut.” In the exemplary embodiment shown by FIGS. 12A and 12B, a circular segment 1165 is within each of the perforated regions of the lamina 1155, and the segments 1165 are arranged in rows and columns. However, other shapes and other patterns of the segments 1165 are possible in other embodiments. Further, the diameter of each segment 1165 is about 3/16 of an inch, and successive segments 1165 of the same row or column are separated by about ⅛ of an inch. However, other dimensions for the segments 1165 are possible in other embodiments. Note that the thicknesses of the lamina 1155 and layers 1156 and 1157 are exaggerated in FIG. 12B for illustrative purposes.

If desired, the lamina 1155 may be pulled from the liner layer 1156 leaving the segments 1165 on the liner layer 1156. In such an example, the lamina 1155 has holes vacated by the segments 1165. Thus, the lamina 1155 may be attached to a printing medium, such as a document or another label, similar to the laminas described above for the embodiments shown by FIGS. 3A, 4A, and 5A. Thereafter, information may be printed on the printing medium and the lamina 1155, and this information may be obfuscated by removing the lamina 1155 from the printing medium, as described above for the embodiments shown by FIGS. 3A, 4A, and 5A.

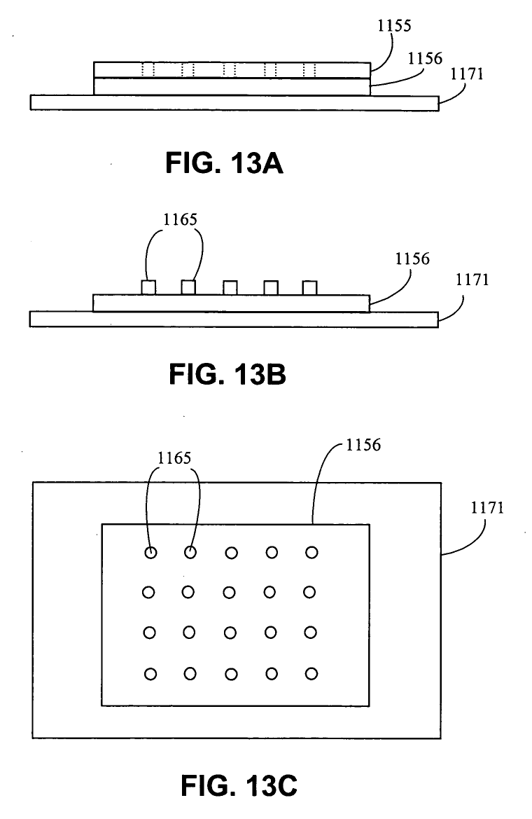

However, another way to use the label 1152 for protecting confidential information is to print confidential information on the label 1152 before removing the lamina 1155. Thus, the confidential information is printed on the lamina 1155 and the segments 1165. Further, the liner layer 1156 may remain on the base layer 1157, or the base layer 1157 may be removed to allow the liner layer 1156 and the lamina 1155 to be attached to another object, such as a container or a document, for example. As an example, the base layer 1157 may be removed from the liner layer 1156, and the liner layer 1156 may be attached to a document 1171, as shown by FIG. 13A, or another object, such as a prescription bottle or other container. Preferably, some of the adhesive material that adheres the liner layer 1156 to the base layer 1157 remains on the liner layer 1156 after removal of base layer 1157 so that the adhesive material may be used to adhere the liner layer 1156 to the document 1171 or other object to which it is attached. Note that confidential information may be printed on the lamina 1155 before or after the liner layer 1156 is attached to the document 1171. In either case, the segments 1165 form at least part of the printing medium on which the confidential information is printed.

When it is desirable to obscure the confidential information printed on the lamina 1155 and segments 1165, the lamina 1155 may be removed leaving the segments 1165 on the liner layer 1156, as depicted by FIGS. 13B and 13C. Since part of the confidential information is on the removed lamina 1155 and part of the confidential information is on at least some of the segments 1165, the confidential information is obscured. In addition, one or more segments 1165 may be removed from the liner layer 1165 possibly further obfuscating the confidential information. Note that, for simplicity of illustration, the printed text on the segments 1165 is not shown in FIG. 13C.

It should be noted that the obscuring effects described herein are based on several factors, including the dimensions of the lamina that is removed and the font style and size of the text defining the confidential information. Generally, for larger font sizes, the size of the perforated regions in the lamina can be larger while still achieving about the same level of obfuscation. In the exemplary embodiment shown above by FIGS. 12A and 12B, it is believed that a font size of 11 point using the Arial font style would be sufficient to make confidential information illegible when the lamina 1155 is removed if the diameter of the circular segments 1165 is 3/16 of an inch and if such segments 1165 are separated by ⅛ of an inch. However, other font sizes and styles are also possible. Indeed, it should be apparent to one of ordinary skill in the art, upon reading this disclosure, that many variations of perforation patterns and dimensions, as well as font styles and sizes, are possible depending on the level of obfuscation desired.

Now, therefore, the following is claimed:

1. An apparatus for protecting confidential information, comprising:
a printing medium having a surface; and
a removable lamina residing on the surface, the lamina having holes for allowing a portion of ink that defines text printed on at least the lamina to pass through the lamina such that the text is obscured when the perforated lamina is removed from the surface.

2. The system of claim 1, wherein the lamina comprises a tab.

3. The system of claim 1, wherein the lamina has a side contacting the surface, and wherein only a portion of the side is adhesive.

4. The system of claim 1, wherein the printing medium is affixed to a container.

5. An apparatus, comprising:
a printing medium; and
a removable lamina having a plurality of perforated regions, the lamina and the printing medium having text printed thereon, wherein ink defining portions of the text printed to the perforated regions resides on the printing medium, and wherein ink defining other portions of the text resides on the lamina such that the text is obscured when the lamina is removed.

6. The apparatus of claim 5, wherein the lamina has a respective hole at each of the perforated regions such that the ink defining the text printed to the perforated regions passes through the lamina before being imprinted on the printing medium.

7. The apparatus of claim 5, wherein said lamina is interspersed with segments of the printing medium.

8. The apparatus of claim 5, further comprising a container, wherein the printing medium is affixed to the container.

9. The apparatus of claim 5, wherein the lamina comprises a tab

10. The apparatus of claim 5, wherein the lamina resides on the printing medium.

11. The apparatus of claim 5, wherein a portion of a word of the text is printed on the printing medium and another portion of the word is printed on the lamina

12. The apparatus of claim 5, further comprising a layer of material, wherein segments of the printing medium are attached to the layer, and wherein the perforated lamina is attached to the layer.

13. A method for protecting confidential information, comprising the steps of:
positioning a perforated lamina on a surface of a printing medium;
applying ink on the lamina such that a portion of the ink resides on the lamina and a portion of the ink passes through holes in the lamina and resides on the printing medium; and
removing the lamina from the surface.

14. The method of claim 13, further comprising the step of affixing the printing medium to a container prior to the removing step.

15. The method of claim 13, wherein the applying step is performed such that a single word is defined by both ink on the lamina and ink on the document.

16. A method, comprising the steps of:
providing a lamina interspersed with a plurality of perforated regions;
printing text on a printing medium and the lamina, wherein ink defining portions of the text printed to the perforated regions resides on the printing medium and ink defining other portions of the text resides on the lamina; and
separating the lamina and the printing medium thereby obscuring the text.

17. The method of claim 16, wherein the lamina has a respective hole at each of the perforated regions, and wherein the printing comprises the step of passing ink through the lamina.

18. The method of claim 16, further comprising the step of affixing the printing medium to a container.

19. The method of claim 16, further comprising the step of attaching the lamina and the printing medium to a layer of material.

20. The method of claim 16, wherein the printing step further comprises the steps of printing a portion of a word on the printing medium and printing another portion of the word on the lamina.
